(19) United States
(12) Patent Application Publication
(10) Pub. No.: US 2026/0017545 A1
(43) Pub. Date: Jan. 15, 2026

(54) ARTIFICIAL INTELLIGENCE ASSISTANT SYSTEM AND ARTIFICIAL INTELLIGENCE OPERATION METHOD

(71) Applicant: INDUSTRIAL TECHNOLOGY RESEARCH INSTITUTE, Hsinchu (TW)

(72) Inventors: Guan-Ying CHEN, Taoyuan City (TW); Po-Huan CHOU, Zhubei City (TW)

(73) Assignee: INDUSTRIAL TECHNOLOGY RESEARCH INSTITUTE, Hsinchu (TW)

(21) Appl. No.: 19/266,804

(22) Filed: Jul. 11, 2025

Related U.S. Application Data
(60) Provisional application No. 63/671,305, filed on Jul. 15, 2024.

(30) Foreign Application Priority Data
Jun. 23, 2025 (TW) 114123507

(51) Int. Cl. G06N 5/043

(52) U.S. Cl. CPC G06N 5/043

(57) ABSTRACT

An artificial intelligence assistant system and an artificial intelligence operation method are provided. The artificial intelligence assistant system includes at least one interactive module, a perception module and an integrated response module. The interactive module is used to receive an input message. The perception module is connected to the interactive module. The perception module includes a plurality of artificial intelligence functional units. The interactive module infers a joint execution program for the artificial intelligence functional units according to the input message, so that the artificial intelligence functional units provide a plurality of operation signals to at least one functional device and obtain a plurality of operation results. The integrated response module is connected to the perception module. The integrated response module is used to integrate the operation results to infer a response message.

This application claims the benefit of U.S. provisional application Ser. No. 63/671,305, filed Jul. 15, 2024 and Taiwan application Serial No. 114123507, filed Jun. 23, 2025, the subject matters of which are incorporated herein by reference.

### TECHNICAL FIELD

The disclosure relates in general to an artificial intelligence assistant system and an artificial intelligence operation method.

### BACKGROUND

Artificial Intelligence (AI) technology can quickly learn and reason in massive amounts of data, excel in identifying patterns, automating repetitive tasks, and excels in areas such as speech recognition, image recognition, natural language processing, etc. Through powerful computing power and training architecture, AI can help companies improve efficiency, reduce labor costs, and promote intelligent decision-making. For example, chatbots in customer service systems, predictive maintenance in manufacturing, and medical diagnostic aids have all proven the practicality and high value of AI.

Although super models have the powerful ability to handle a variety of tasks, the super models also come with obvious technical limitations. Firstly, such models have extremely high computational intensive, and thus they are usually unable to be executed on local devices. They must rely on cloud platforms for reasoning and training, resulting in high energy and infrastructure costs. Second, the operating mechanism of super models is mostly black-box processing, it makes it difficult for users to understand their internal logic and decision-making process, thereby reducing trust and regulatory transparency. In addition, the behavior of such super models is highly concentrated on what is learned during a training phase, lacking flexibility and adjustability, and is difficult to quickly adjust or customize according to specific application scenarios.

### SUMMARY

The disclosure relates to an artificial intelligence assistant system and an artificial intelligence operation method, which equip multiple micro (basic/expert) functional models with one or more prompt interfaces by using joint feature perception technology, so that these functional models can actively adjust a work content they perform according to external prompts. In addition, the artificial intelligence assistant system of the disclosure allows a combination of the artificial intelligences (AI to AI). These functional models can perform distributed computing and can operate at the on-premises with a very high energy efficiency ratio. In addition, the entire system process can be effectively controlled, and the system can be quickly expanded in terms of functions.

According to an embodiment, an artificial intelligence assistant system is provided. The artificial intelligence assistant system includes at least one interactive module, a perception module and an integrated response module. The interactive module is configured for receiving an input message. The perception module is connected to the at least one interactive module, wherein the perception module includes a plurality of artificial intelligence functional units, wherein the interactive module infers a joint execution program for the artificial intelligence functional units according to the input message, so that the artificial intelligence functional units provide a plurality of operation signals to at least one functional device and obtain a plurality of operation results. The integrated response module is connected to the perception module, wherein the integrated response module is configured to integrate the operation results to infer a response message.

According to another embodiment, an artificial intelligence operation method is provided. The artificial intelligence operation method includes the following steps: receiving an input message; according to the input message, inferring a joint execution program for a plurality of artificial intelligence functional units, so that the artificial intelligence functional units provide a plurality of operation signals to at least one functional device and obtain a plurality of operation results; and integrating the operation results to infer a response message.

### BRIEF DESCRIPTION OF THE DRAWINGS

FIG. 1 illustrates a schematic diagram of an artificial intelligence assistant system according to an embodiment of the disclosure;

FIG. 2 illustrates a flow chart of an artificial intelligence operation method according to an embodiment of the disclosure;

FIG. 3 illustrates a schematic diagram of the expansion of the application scenario of the functional model combination according to an embodiment of the disclosure;

FIG. 4 illustrates a schematic diagram of the joint feature perception technology according to an embodiment;

FIG. 5 illustrates a schematic diagram of an auto-regressive generation and retrieval technology according to an embodiment;

FIG. 6 shows a block diagram of the artificial intelligence assistant system 100 according to an embodiment of the disclosure;

FIG. 7 shows a schematic diagram of an operation field according to an artificial intelligence assistant system according to an embodiment;

FIG. 8 shows a schematic diagram of an operation process according to an artificial intelligence assistant system according to an embodiment;

FIG. 9 illustrates a schematic diagram of a scenario of the interactive module in “reservation time period”;

FIG. 10 illustrates a schematic diagram of a scenario of the interactive module and the perception module in the “assisting practice”;

FIG. 11 illustrates a schematic diagram of a scenario of the integrated response module in “assisting practice” and “analyzing and improving”;

FIG. 12 illustrates a schematic diagram of the addition and deletion of the artificial intelligence function unit; and

FIG. 13 illustrates a schematic diagram of the artificial intelligence operation method of the disclosure according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms in this specification refer to the customary terms in the technical field. If some terms are explained or defined in this specification, the interpretation of these terms shall be based on the explanation or definition in this specification. Each embodiment of the disclosure has one or more technical features. Under the premise of possible implementation, a person with ordinary knowledge in the technical field can selectively implement some or all of the technical features in any embodiment, or selectively combine some or all of the technical features in these embodiments.

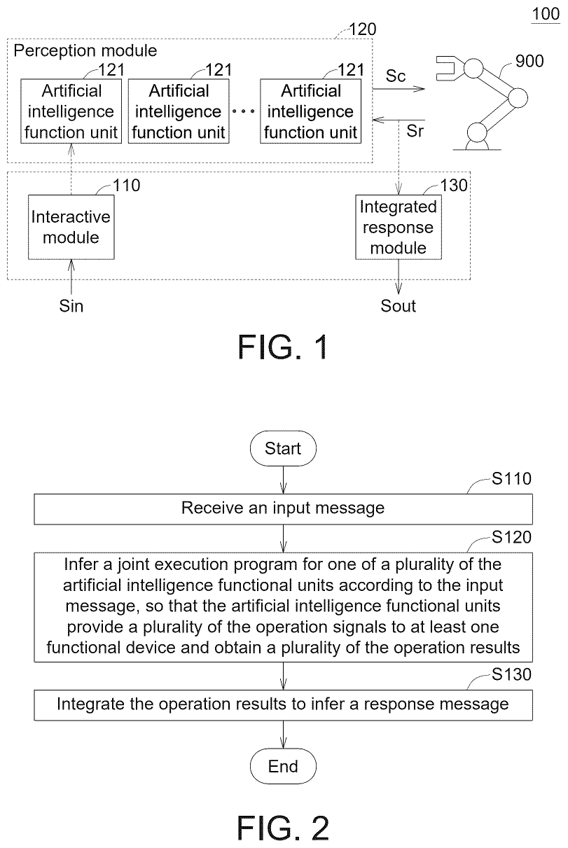

Referring to FIG. 1, FIG. 1 illustrates a schematic diagram of an artificial intelligence assistant system 100 according to an embodiment of the disclosure. The artificial intelligence assistant system 100 includes at least one interactive module 110, a perception module 120 and an integrated response module 130. The interactive module 110 is used for users to input various messages. The perception module 120 includes one or more artificial intelligence function units 121. The artificial intelligence function unit 121 is configured to perform various artificial intelligence inference procedures. The integrated response module 130 is configured to integrate various inferences and operation results.

In an embodiment, the interactive module 110 may be a large language model using a certain prompt interface, the integrated response module 130 may be another large language model using a certain prompt interface, and the artificial intelligence function unit 121 may be various different micro (basic/expert) function models applicable to different modal information, for example, a supervised learning models, an unsupervised learning model, a generative model, wherein the supervised learning models includes, for example, decision tree, support vector machine (SVM), neural network, etc., the unsupervised learning models includes, for example, K-means clustering, principal component analysis (PCA), autoencoder, etc., and the generative model includes, for example, generative adversarial network (GAN), diffusion model, autoregressive model, etc. The interactive module 110, the perception module 120, the artificial intelligence function unit 121 and/or the integrated response module 130 are, for example, a circuit, a circuit board, a storage device storing program code, or a chip. The chip is, for example, a central processing unit (CPU), or other programmable general-purpose or a special-purpose micro-control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar components or combinations of the above components.

According to the description of FIG. 1 above, the disclosure proposes an implementation method for artificial intelligence applications at a brain level of an enterprise. This method is to equip multiple micro (basic/expert) functional models with one or more prompt interfaces through joint feature perception technology, so that these functional models can actively adjust the work content they perform according to external prompts. The following is a detailed description of the operation of each component with an embodiment.

Referring to FIG. 2, FIG. 2 illustrates a flow chart of an artificial intelligence operation method according to an embodiment of the disclosure. The artificial intelligence operation method is executed by, for example, loading a computer program code stored in a computer-readable recording medium through a computer, a processor or an electronic device. In step S110, as shown in FIG. 1, the interactive module 110 receives an input message Sin. Then, in step S120, as shown in FIG. 1, the perception module 120 infers a joint execution program for one of a plurality of the artificial intelligence functional units 121 according to the input message Sin, so that the artificial intelligence functional units 121 provide a plurality of the operation signals Sc to at least one functional device (such as a robot arm 900) and obtain a plurality of the operation results Sr. Then, in step S130, as shown in FIG. 1, the integrated response module 130 integrates these operation results Sr to infer a response message Sout.

Furthermore, the disclosure allows the combination of artificial intelligences (AI to AI). These functional models can perform distributed computing and can operate at the on-premises, with a very high energy efficiency ratio. In addition, the entire system process can be effectively controlled, and the system can be quickly expanded.

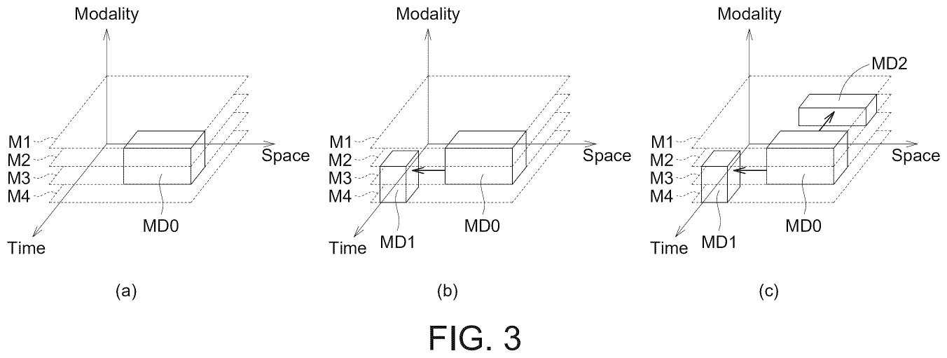

Referring to FIG. 3, FIG. 3 illustrates a schematic diagram of the expansion of the application scenario of the functional model combination according to an embodiment of the disclosure. As shown in the diagram at (a) of FIG. 3, the functional model MD0 is applicable to a voice mode M2 and a text mode M3 for dialogue or answering questions. As shown in the diagram at (b) of FIG. 3, after the functional model MD0 is integrated with the functional model MD1, it can be expanded to a visual mode M4 for image retrieval. As shown in the diagram at (c) of FIG. 3, after the functional model MD0 is integrated with the functional model MD1 and then integrated with the functional model MD3, it can be expanded to the signal mode M1 for signal recognition.

Through the integration of various functional models MD0, MD1, MD2, . . . , the functional scope of the intelligent assistant can be freely defined, expanded, and connected in series without being restricted by the specifications given by a specific model. In industry, it can reduce the maintenance cost of enterprises applying artificial intelligence and expand more applicable scenarios. In addition, the entire system is controllable and lightweight, and it is easy to avoid losses caused by hallucinations caused by artificial intelligence.

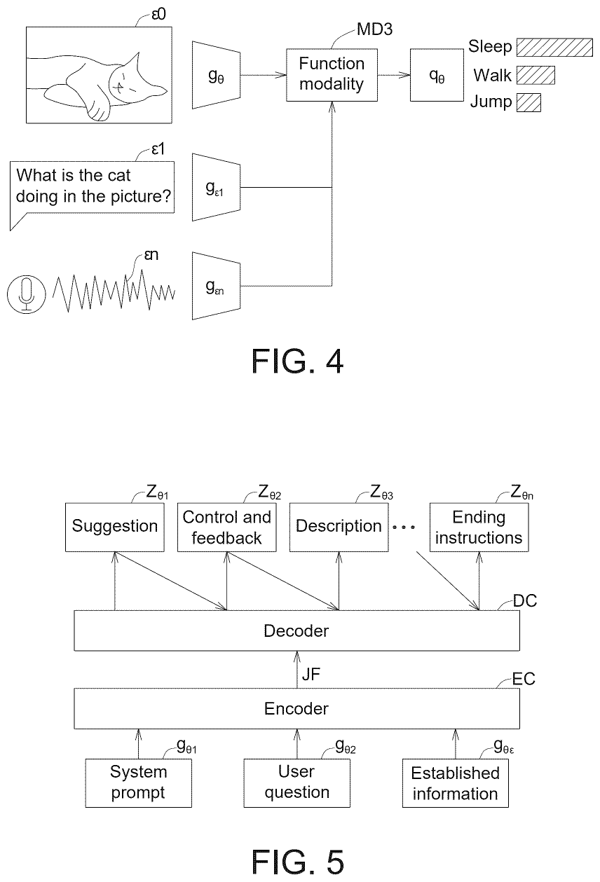

Referring to FIG. 4, FIG. 4 illustrates a schematic diagram of the joint feature perception technology according to an embodiment. In the disclosure, the artificial intelligence assistant system 100 achieves multi-modal expansion and application by using the joint feature perception technology. The joint feature perception technology is the technology that allows functional models of various tasks to support different input modalities ε0, ε1, . . . , εn. It adds n self-supervisory codecs g_{ε1}, . . . , g_{εn} to the original codec g_{θ} architecture, so that the functional model MD3 can take into account the prompts given by each input modality ε0, ε1, . . . , εn when making predictions, so as to fine-tune the output q_{θ} of the functional model MD3.

Referring to FIG. 5, FIG. 5 illustrates a schematic diagram of an auto-regressive generation and retrieval technology according to an embodiment. In the disclosure, the artificial intelligence assistant system 100 achieves a flexible inference and a prediction by using the auto-regressive generation and retrieval technology. In the architecture of the auto-regressive generation and retrieval technology, it mainly performs a sequence generation by using the Transformer-based neural network combined with the conditional features. “problem state” and “goal” are converted into the conditional features, and a series of downward predictions (Next Step Prediction) are performed through the Transformer to generate various decisions and behaviors.

Encoder EC is used to convert multiple input messages into a joint feature (Joint Feature) JF. The input of the encoder EC is, for example, a system prompt g_{θ1} (a command prompt, a background context, etc.), a user question g_{θ2} (such as a query, a task request) or an established information g_{θε} (such as an environmental state, a knowledge base, a goal setting).

Encoder EC can encode these conditions into an overall semantic vector (joint feature JF) and provide it to the decoder DC for use. The decoder DC gradually provides a series of predictions according to the joint features JF: a suggestion Z_{θ1}, a control and feedback Z_{θ2}, a description Z_{θ3}, . . . , an ending instructions Z_{θn}.

By using the auto-regressive generation and retrieval technology, the joint feature space can be constructed by a neural network, and by actively providing inputs of different modalities, the state/goal of the problem can be converted into conditional features, and then realize multiple modal decisions and behaviors through a series of uninterrupted downward predictions (Next Step).

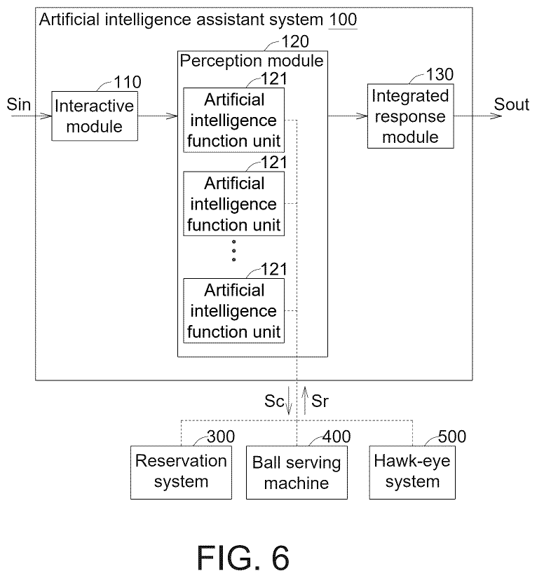

Referring to FIG. 6, FIG. 6 shows a block diagram of the artificial intelligence assistant system 100 according to an embodiment of the disclosure. The perception module 120 is connected to the interaction module 110. The integrated response module 130 is connected to the perception module 120. The artificial intelligence assistant system 100 of the disclosure is an intelligent assistant system and method (Assembly of Expert, AoE) that combines multiple artificial intelligence models through a joint feature perception interface.

After the input message Sin is input into the artificial intelligence assistant system 100, an appropriate response message Sout can be appropriately given after the artificial intelligence function unit 121 performs a series of inferences and manipulates various functional devices.

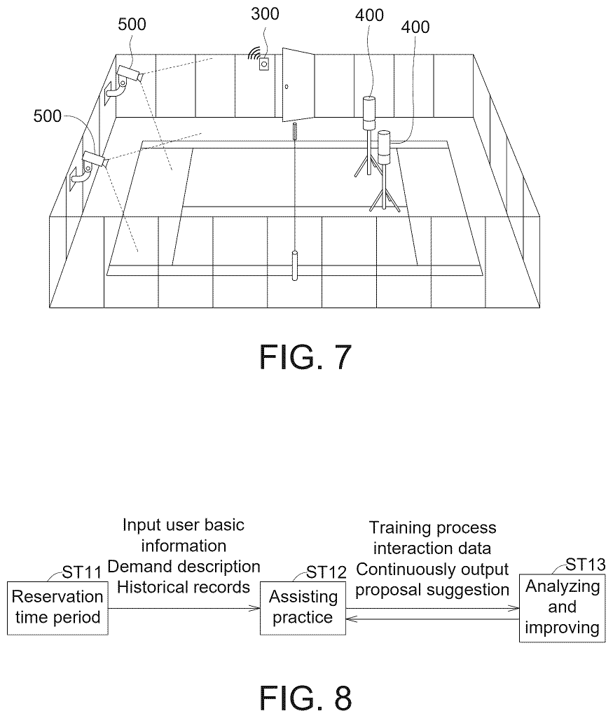

Referring to FIGS. 7 and 8, FIG. 7 shows a schematic diagram of an operation field according to an artificial intelligence assistant system 100 according to an embodiment, and FIG. 8 shows a schematic diagram of an operation process according to an artificial intelligence assistant system 100 according to an embodiment. FIG. 7 is an example of a smart hitting practice field of a badminton center. In the badminton center, the artificial intelligence function unit 121 is configured to manipulate various control function devices (for example, including a reservation system 300, a ball serving machine 400, a hawk-eye system 500, etc.).

As shown in FIG. 8, in a stage ST11, the user can perform the “reservation time period” by using the interactive module 110. At this time, the interactive module 110 can obtain the input message Sin such as user's basic information, demand description, historical records, etc.

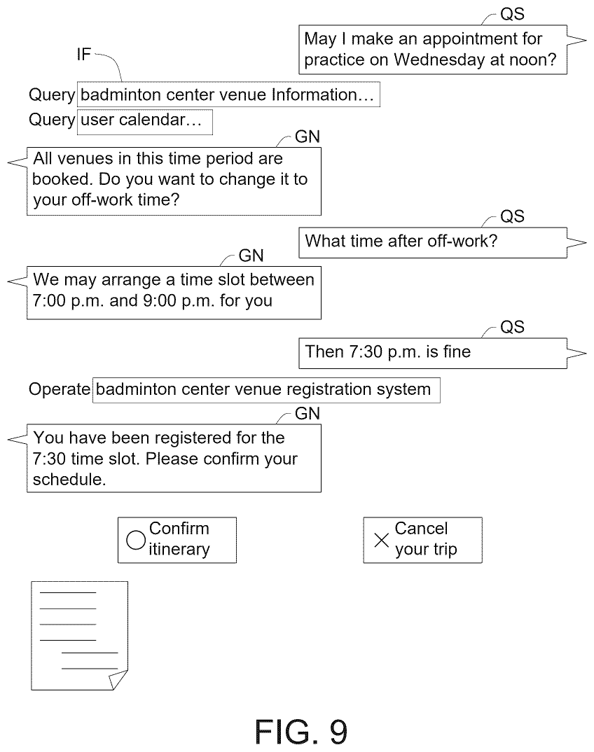

Referring to FIG. 9, FIG. 9 illustrates a schematic diagram of a scenario of the interactive module 110 in “reservation time period”. During the process of the reservation time period, the user can ask a user question QS. The interactive module 110 can query the established information IF and provide the generated content GN to the user. After a series of interactions, the user can successfully book the desired practice time period.

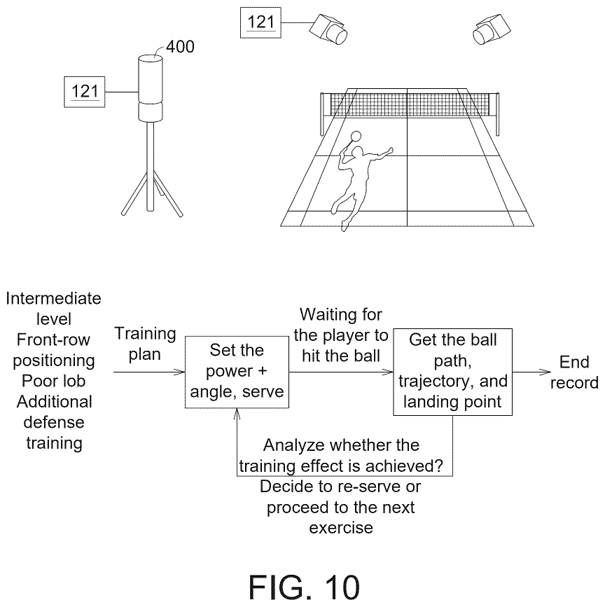

As shown in FIG. 8, in a stage ST12, the artificial intelligence function unit 121 of the perception module 120 performs “assisting practice” according to the needs of the user. Referring to FIG. 10, FIG. 10 illustrates a schematic diagram of a scenario of the interactive module 110 and the perception module 120 in the “assisting practice”. The interactive module 110 can infer a training plan according to the input message Sin such as intermediate level, front-row positioning, poor lob, and additional defense training. The training plan is a joint execution program for functional devices such as the ball serving machine 400 and the hawk-eye system 500. The joint execution program, for example, includes an artificial intelligence function unit inferring a serving power and a serving angle of the ball serving machine 400 and setting the serving power and the serving angle. After waiting for the user to hit the ball, the joint execution program, for example, includes an artificial intelligence function unit inferring a control signal requiring the hawk-eye system 500 to obtain information such as a ball path, a trajectory, and a landing point. The joint execution program, for example, further includes an artificial intelligence function unit analyzing whether the training effect has been achieved? and decide to re-serve or perform the next step of practice.

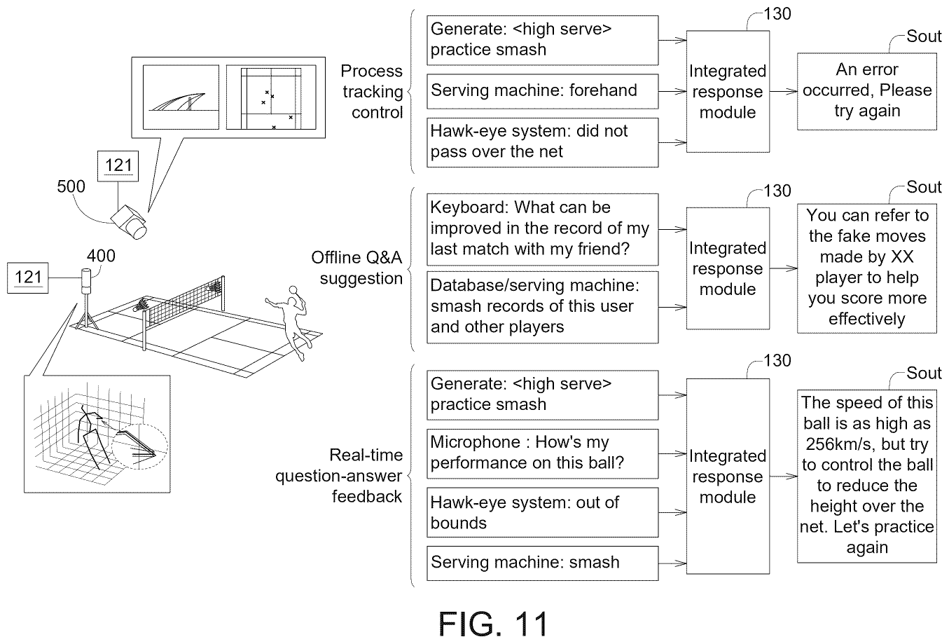

As shown in FIG. 8, in a stage ST13, the integrated response module 130 analyzes and improves according to the data related to the training process. Referring to FIG. 11, FIG. 11 illustrates a schematic diagram of a scenario of the integrated response module 130 in “assisting practice” and “analyzing and improving”. For example, the integrated response module 130 can assist in “process tracking control”. In the case of practicing smash, the ball serving machine 400 gives a forehand ball path, but the hawk-eye system 500 detects that the user has not hit the ball over the net. At this time, after integrating these information, the integrated response module 130 infers the response message Sout of “an error occurred, please try again”.

In addition, the integrated response module 130 can assist in “offline Q&A suggestion”. The user can ask through the keyboard “What can be improved in the record of my last match with my friend?” The database can search the smash records of the user and other players, and after the integrated response module 130 integrates the information, it infers the response message Sout of “you can refer to the fake moves made by XX player to help you score more effectively”.

Furthermore, the integrated response module 130 can assist in “real-time question-answer feedback”. During the process of practicing smashing, the user can input the voice “How's my performance on this ball?” through a microphone. The Hawkeye system 500 detects that the ball is out of bounds, and the ball serving machine 400 uses a spike. After integrating various information, the integrated response module 130 infers the response message Sout of “The speed of this ball is as high as 256 km/s, but try to control the ball to reduce the height over the net. Let's practice again.”

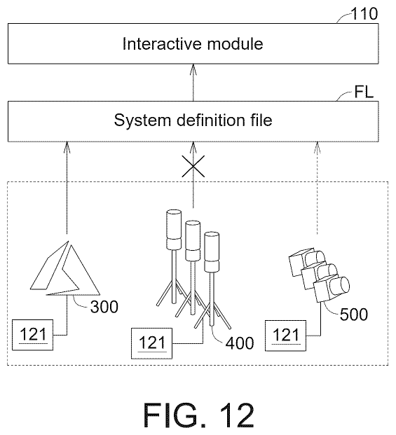

The above-mentioned artificial intelligence function unit 121 is not fixed, and the user can add or delete the artificial intelligence function unit 121 at any time. Referring to FIG. 12, FIG. 12 illustrates a schematic diagram of the addition and deletion of the artificial intelligence function unit 121. During the operation of the artificial intelligence assistant system 100, the interactive module 110 infers the joint execution program of these artificial intelligence function units 121 according to the input message Sin and a system definition file FL. The system definition file FL defines the functions, affiliations and operation methods of these artificial intelligence function units 121. For example, in the system definition file FL, the artificial intelligence function unit 121 used in the ball serving machine 400 can be deleted, and the artificial intelligence function unit 121 used in the reservation system 300 can be added.

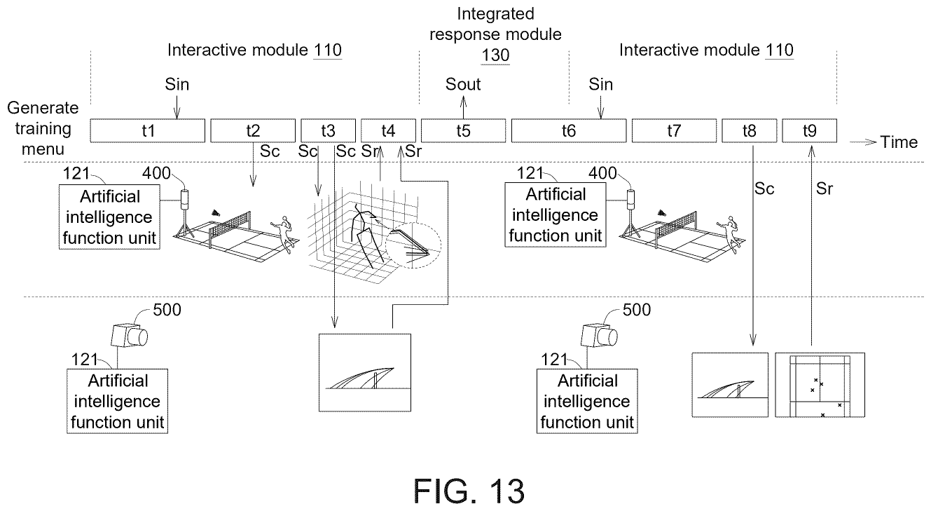

In addition, each step of the artificial intelligence operation method of the disclosure can be repeated and executed continuously to achieve a long-term and complete intelligent activity. For example, Referring to FIG. 13, FIG. 13 illustrates a schematic diagram of the artificial intelligence operation method of the disclosure according to an embodiment. In the time interval t1, the interactive module 110 receives the input message Sin to infer the joint execution program of a plurality of the artificial intelligence function units 121. In the time interval t2, the artificial intelligence function unit 121 provides the function device of the ball serving machine 400 with an operation signal Sc of “setting the serving parameter”. In the time interval t3, the artificial intelligence function unit 121 provides the function device of the ball serving machine 400 with an operation signal Sc of “analyzing the limb joint coordinate”, and provides the function device of the hawk-eye system 500 with the operation signal Sc of “shooting the ball path trajectory”. At time interval t4, the functional device of the ball serving machine 400 provides the operation result Sr of “limb joint coordinates”, and the functional device of the hawk-eye system 500 provides the operation result Sr of “ball trajectory coordinate and limb joint coordinate”. At time interval t5, the integrated response module 130 integrates the operation result Sr to infer the response message Sout.

At time interval t6, after the integrated response module 130 replies to the user with the response message Sout, the user can immediately input the input message Sin of “practice again” through the interactive module 110. At time point t7, the artificial intelligence function unit 121 provides the operation signal Sc of “setting serving parameter” to the function device of the ball serving machine 400. At time interval t8, the artificial intelligence function unit 121 provides the operation signal Sc of “shooting ball path trajectory” to the function device of the hawk-eye system 500. At time interval t9, the function device of the hawk-eye system 500 provides the operation result Sr of “replying ball path trajectory coordinate”. By analogy, each step of the artificial intelligence operation method of the disclosure can be repeated and executed continuously to achieve the long-term and complete intelligent activity.

According to the above embodiment, the artificial intelligence operation method of the disclosure is to equip multiple micro (basic/expert) function models with one or more prompt interfaces by using joint feature perception technology, so that these function models can actively adjust the work content they perform according to external prompts. The artificial intelligence assistant system 100 of the disclosure allows the combination of the artificial intelligences (AI to AI). These function models can perform distributed computing and can operate at the on-premises, with a very high energy efficiency ratio. In addition, the entire system process can be effectively controlled, and the system can be quickly expanded.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. An artificial intelligence assistant system, comprising:
at least one interactive module configured for receiving an input message;
a perception module connected to the at least one interactive module, wherein the perception module comprises:
a plurality of artificial intelligence functional units, wherein the interactive module infers a joint execution program for the artificial intelligence functional units according to the input message, so that the artificial intelligence functional units provide a plurality of operation signals to at least one functional device and obtain a plurality of operation results; and
an integrated response module connected to the perception module, wherein the integrated response module is configured to integrate the operation results to infer a response message.

2. The artificial intelligence assistant system as claimed in claim 1, wherein the artificial intelligence functional units are configured to perform different inference procedures.

3. The artificial intelligence assistant system as claimed in claim 1, wherein the artificial intelligence functional units are configured to receive messages of different modalities.

4. The artificial intelligence assistant system as claimed in claim 1, wherein the artificial intelligence functional units are configured to output messages of different modalities.

5. The artificial intelligence assistant system as claimed in claim 1, wherein the interactive module is a large language model.

6. The artificial intelligence assistant system as claimed in claim 1, wherein the interactive module infers the joint execution program for the artificial intelligence functional units according to the input message and a system definition file, and the system definition file defines a function, an affiliation and an operation method of the artificial intelligence functional units.

7. The artificial intelligence assistant system as claimed in claim 1, wherein the joint execution program activates all of the artificial intelligence functional units.

8. The artificial intelligence assistant system as claimed in claim 1, wherein the joint execution program activates a portion of the artificial intelligence functional units.

9. The artificial intelligence assistant system as claimed in claim 1, wherein the integrated response module is a large language model.

10. The artificial intelligence assistant system as claimed in claim 1, wherein the response message inferred by the integrated response module is directly output by an output unit or fed back to the interactive module as the input message.

11. An artificial intelligence operation method, comprising:
receiving an input message;
according to the input message, inferring a joint execution program for a plurality of artificial intelligence functional units, so that the artificial intelligence functional units provide a plurality of operation signals to at least one functional device and obtain a plurality of operation results; and
integrating the operation results to infer a response message.

12. The artificial intelligence operation method as claimed in claim 11, wherein the artificial intelligence functional units are configured to perform different inference procedures.

13. The artificial intelligence operation method as claimed in claim 11, wherein the artificial intelligence functional units are configured to receive messages of different modalities.

14. The artificial intelligence operation method as claimed in claim 11, wherein the artificial intelligence functional units are configured to output messages of different modalities.

15. The artificial intelligence operation method as claimed in claim 11, wherein the input message is a text message or a voice message.

16. The artificial intelligence operation method as claimed in claim 11, wherein in step of inferring the joint execution program for the artificial intelligence functional units, an inference is made based on the input message and a system definition file, wherein the system definition file defines a function, an affiliation and an operation method of the artificial intelligence functional units.

17. The artificial intelligence operation method as claimed in claim 11, wherein the joint execution program activates all of the artificial intelligence functional units.

18. The artificial intelligence operation method as claimed in claim 11, wherein the joint execution program activates a portion of the artificial intelligence functional units.

19. The artificial intelligence operation method as claimed in claim 11, wherein the response message is a text message or a voice message.

20. Then artificial intelligence operation method as claimed in claim 11, wherein the response message is directly output by an output unit or serves as the input message.
